(19) United States
(12) Patent Application Publication
(10) Pub. No.: US 2014/0221495 A1
(43) Pub. Date: Aug. 7, 2014

(54) ELECTROSPUN POLYMER NANOFIBERS WITH SURFACE ACTIVE QUATERNARY AMMONIUM SALT ANTIMICROBIALS

(71) Applicants: Peter N. Coneski, Alexandria, VA (US); Jeffrey G. Lundin, Springfield, VA (US); Preston A. Fulmer, Richmond, VA (US); James H. Wynne, Alexandria, VA (US)

(72) Inventors: Peter N. Coneski, Alexandria, VA (US); Jeffrey G. Lundin, Springfield, VA (US); Preston A. Fulmer, Richmond, VA (US); James H. Wynne, Alexandria, VA (US)

(73) Assignee: The Government of the United States of America, as reperesented by the Secretary of the Navy, Washington, DC (US)

(21) Appl. No.: 13/832,302

(22) Filed: Mar. 15, 2013

Related U.S. Application Data
(60) Provisional application No. 61/761,328, filed on Feb. 6, 2013.

(51) Int. Cl. A01N 33/12; D01D 5/00

(52) U.S. Cl. CPC A01N 33/12; D01D 5/0023
USPC 514/642; 264/484; 264/413

(57) ABSTRACT

A fiber having a polymeric matrix and a quarternary ammonium salt. The quarternary ammonium salt contains at least one aliphatic group and no aromatic groups, is not covalently incorporated into the polymeric matrix, and is present on both the surface and in the interior of the fiber. The fiber may be made by electrospinning a solution of the polymer and the quarternary ammonium salt.

This application claims the benefit of U.S. Provisional Application No. 61/761,328, filed on Feb. 6, 2013. The provisional application and all other publications and patent documents referred to throughout this nonprovisional application are incorporated herein by reference.

### TECHNICAL FIELD

The present disclosure is generally related to antimicrobial fibers

### DESCRIPTION OF RELATED ART

Bacterial contamination of clothing and other assets is of constant concern, particularly due to the emergence of antibiotic resistant bacteria. Personnel in hospitals, health care clinics, and military settings are at particular risk (Obendorf, AATCC Rev. 2010, 10, 44-50). Common routes of exposure for these individuals to infectious microbes occur through contact with clothing, bed sheets, and other fabrics contaminated with harmful bacteria. There has been work in the field to create antimicrobial fibers with nano-scale diameters. Fibers with nano-scale diameters exhibit extremely high surface area to volume ratios, which are highly desirable for an antimicrobial surface.

Electrospinning has recently emerged as a promising method through which to develop novel polymeric fiber and fabric formulations for biological threat protection (Chen et al., Chem. Mater. 2010, 22, 1429-1436; Yoon et al., J. Mater. Chem. 2008, 18, 5326-5334). Electrospinning is an intricate process which utilizes electrostatic forces to create polymeric, ceramic, and sol-gel fibers with nano-scale diameters (Reneker et al., Polymer 2008, 49, 2387-2425). Numerous critical parameters must be controlled for the optimal production of fibers by electrospinning including but not limited to solvent selection, polymer concentration, power supply voltage, and distance to target (Deitzel et al., Polymer 2001, 42, 261-272; Theron et al., Polymer 2004, 45, 2017-2030). However, incorporation of additives, and particularly ionic molecules, into the electrospinning solution significantly affects fiber morphology and diameter (Arumugam et al., Macromol. Mater. Eng. 2009, 294, 45-53; Seo et al., Macromol. Mater. Eng. 2009, 294, 35-44).

Antimicrobial materials have been developed that release biocidal molecules and compounds. Electrospun fibers which release nitric oxide over time have been developed with the aim to reduce infection resulting from implantable materials (Coneski et al., ACS Appl. Mater. Interfaces 2011, 3, 426-432). Chlorhexidine, a biocide, has been incorporated into electrospun cellulose acetate fibers resulting in an antibacterial material which leached biocide and produced a notable zone of inhibition (Chen et al., Polymer 2008, 49, 1266-1275). However, leaching biocides present opportunities for biocidal compounds to accumulate in environmental matrices and exhibit reduced antimicrobial activity over the lifetime of the material.

While many polymers have previously been utilized to create fibers through electrospinning, successful functionalization with biocidal additives has the potential to afford benefits for various applications due to the robust physical properties, safety, and cost of the polymer systems. The focus of much electrospinning research has centered on nylon and the effects of electrospinning conditions on the properties of resultant fibers (Ojha et al., J. Appl. Polym. Sci. 2008, 108, 308-319). Work has also been performed in regard to optimal conditions for electrospinning polycarbonate due its attractive structural properties (Kim et al., Eur. Polym. J. 2007, 43, 3146-3152; Shawon et al., J. Mater. Sci. 2004, 39, 4605-4613). Recent literature has documented conditions by which to electrospin uniform fibers with micro- to nano-scale diameters for both nylon and PC (Kim et al., Eur. Polym. J. 2007, 43, 3146-3152; Shawon et al., J. Mater. Sci. 2004, 39, 4605-4613; Tsou et al., Polymer 2011, 52, 3127-3136; Tan et al., J. Membr. Sci. 2007, 305, 287-298).

Many approaches have been taken to develop antimicrobial polymer surfaces, of which, several can be tailored to electrospinning Polymeric surfaces have been functionalized post application and successfully resulted in antibacterial surfaces (Schiffman et al., ACS Appl. Mater. Interfaces 2011, 3, 462-468; Yao et al., J. Membr. Sci. 2008, 320, 259-267). Nylon 6,6 electrospun fibers exhibiting antimicrobial properties have likewise been created through incorporation of N-halamine additives (Tan et al., J. Membr. Sci. 2007, 305, 287-298; Zhu et al., J. Mater. Chem. 2012, 22, 8532-8540). Benzyl triethylammonium chloride has been incorporated into electrospun polycarbonate fibers and found to improve antimicrobial activity (Kim et al., Eur. Polym. J. 2007, 43, 3146-3152). Additives have been used to electrospin superhydrophobic fibers from solutions of polystyrene and surface segregating fluoroalkyl additives (Hardman et al., Macromolecules 2011, 44, 6461-6470). Each of these, however, requires either some form of additional treatment after fabrication or reactivation of the biocidal component prior to subsequent challenges. Another post-treatment approach, while effective, requires continual recharging of a halamine biocide with chlorine rinse in order to maintain antimicrobial behavior (Qian et al., J. Appl. Polym. Sci. 2003, 89, 2418-2425). While these approaches can result in highly functionalized surfaces, they also require additional processing steps thereby increasing application time, limiting practicality, and increasing cost. A different approach covalently incorporates biocides as monomers in the polymer backbone which has resulted in polymers exhibiting very promising antibacterial properties (Coneski et al., Langmuir 2012, 28, 7039-7048). However, covalent modification of the polymer with biocidal monomers alters the physical properties of the polymer and would result in a large proportion of the biocide to be buried within the bulk of the polymer, as opposed to at the surface where microbial interaction is likely to occur.

### BRIEF SUMMARY

Disclose herein is a fiber comprising a polymeric matrix and a quarternary ammonium salt. The quarternary ammonium salt contains at least one aliphatic group and no aromatic groups, is not covalently incorporated into the polymeric matrix, and is present on both the surface and in the interior of the fiber.

Also disclosed herein is a method comprising electrospinning a solution of a polymeric matrix and a quarternary ammonium salt to produce the above fiber.

### BRIEF DESCRIPTION OF THE DRAWINGS

A more complete appreciation of the invention will be readily obtained by reference to the following Description of the Example Embodiments and the accompanying drawings.

FIG. 1 shows SEM micrographs (10,000×mag.) of electrospun PC fibers containing no additive (a), 1 wt. % CTAB (b), 5 wt. % CTAB (c), 10 wt. % CTAB (d), 1 wt. % C16EO1 (e), 5 wt. % C16EO1 (f), and 10 wt. % C16EO1 (g).

FIG. 2 shows SEM micrographs (20,000×mag.) of electrospun nylon fibers containing no additive (a), 1 wt. % CTAB (b), 5 wt. % CTAB (c), 10 wt. % CTAB (d), 1 wt. % C16EO1 (e), 5 wt. % C16EO1 (f), and 10 wt. % C16EO1 (g).

FIG. 3 shows average log reduction S. aureus on nylon and PC electrospun fibers containing quaternary ammonium salts.

FIG. 4 shows a comparison of Gram-positive log reduction and surface concentration of QAS in nylon fibers.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is the use of electrospinning to generate antimicrobial nylon and polycarbonate (PC) fibers for potential applications including fabrics, filters, and self-decontaminating materials. A non-woven mat composed of fibers impregnated with continuously active biocides on their surfaces has potential to greatly mitigate the risks of contagion. The co-electrospinning of soluble quaternary ammonium biocides within a polymeric solution can generate non-woven mats with uniform fiber diameters. Fiber morphology and diameter of the resulting fibers may be dependent on polymer type and biocide concentration. For example, average nylon fiber diameters increased by 278% and average polycarbonate diameters decreased by 76% at 10% w/w quaternary ammonium salt loadings. There can be a positive correlation between surface concentration of quaternary ammonium salts and antimicrobial activity. Increased amphiphilicity of QAS is expected to increase the surface concentration of QAS in electrospun fibers and improved biocidal surfaces.

A solution-based additive approach is beneficial in that it allows one to maintain electrospinning conditions, of which there are numerous variables to optimize, from those developed for the unmodified polymer solution. The variety of parameters on which the electrospinning process depends includes applied voltage, polymer flow rate, solution composition, and distance to target (Reneker et al., J. Appl. Phys. 2000, 87, 4531-4547). Several recent works in the field have optimized many parameters (Deitzel et al., Polymer 2001, 42, 261-272; Coneski et al., ACS Appl. Mater. Interfaces 2011, 3, 426-432). However, unless the additive preferentially orients at the polymer interface, the additive is likely to disperse throughout the bulk of the coating unable to interact with surface residing microbes, and limit biocidal activity.

Surface segregation of biocidal additives in electrospun fibers has not been previously investigated. Quaternary ammonium salts (QAS) are reported to mediate broad-spectrum bacterial killing through a cationic interaction with the cell membrane (Kugler et al., Microbiology 2005, 151, 1341-1348). While numerous QAS are effective antimicrobial agents, the QAS may be selected based on how it incorporates into a polymer matrix for materials applications. Considerations may include those such as ultimate polymer appearance, stability, adhesion, and workability. Additionally, antibacterial activity of a surface may be dependent on the relative concentration of biocide at the polymer-air interface, where interactions between bacteria and polymer occur (Kurt et al., Langmuir 2007, 23, 4719-4723). Therefore, the interaction of the QAS with the polymer matrix may be considered. Recently, biocidal additives consisting of amphiphilic QAS have been developed which segregate to the air-polymer interface of polymeric coatings during curing when added directly to a polymer solution (Harney et al., ACS Appl. Mater. Interfaces 2009, 1, 39-41; Fulmer et al., ACS Appl. Mater. Interfaces 2010, 2, 1266-1270). Furthermore, amphiphilic QAS have been effective in a variety of polymer matrices, including polyurethane and latex coatings (Wynne et al., ACS Appl. Mater. Interfaces 2011, 3, 2005-2011; Fulmer et al., ACS Appl. Mater. Interfaces 2011, 3, 2878-2884). QAS have also been used in combination with a unique germinant package as polymer additive and exhibited effective activity against Bacillus anthracis (Fulmer et al., ACS Appl. Mater. Interfaces 2012, 4, 738-743).

Any method of producing the fiber may be used including, but not limited to, electrospinning. Electrospinning uses an electrical charge to produce fibers from a liquid. The liquid may ejected from a spinneret connect to a voltage source. The ejected liquid dries to a fiber and lands on a substrate. Some drying may occur on the substrate. Electrospinning techniques known in the art, including as cited herein, may be used to produce the fiber, and any parameters that produce the fiber may be used. Prolonged electrospinning onto the same substrate can produce a mat of one or more of the fibers.

The resulting fiber, whether produced by electrospinning or other methods, comprises a polymeric matrix and a QAS. The QAS contains at least one aliphatic group and no aromatic groups, is not covalently incorporated into the polymeric matrix, and is present on both the surface and in the interior of the fiber. Depending on the properties of the QAS, its concentration on the surface of the fiber may be greater than its concentration in the interior. However, at least some QAS would be present in the interior, as opposed to a fiber that has been coated with a QAS after the fiber has been formed. Further, the QAS is not covalently incorporated into the polymer, as it is a separate compound in solution and during electrospinning The fiber may have any diameter that may be produced by electrospinning, including but not limited to up to 5 microns.

The polymeric matrix may be any polymer that can be electrospun and can be dissolved in a solvent along with the QAS. Suitable polymers include, but are not limited to, nylons, nylon 6,6, polycarbonates, and poly(bisphenol A carbonate).

The QAS has at least one aliphatic group, but no aromatic groups, which may assist is producing a higher surface concentration of the QAS. Such QAS may have amphiphilic properties. Suitable QAS include those of the general formula: X⁻R—CH₂—N⁻(CH₃)₂—(CH₂)ₙ—CH₃. X⁻ is an anion such as Br⁻ or any other anion compatible with the QAS and polymer. The anion may be the natural result of the synthesis method for making the QAS. R is CH₃—O—CH₂— or H— and n is positive integer. Suitable values for n include, but are not limited to, 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30. Two example QAS are Br⁻CH₃—O—CH₂—CH₂—N⁺(CH₃)₂—(CH₂)₁₅—CH₃ and Br⁻CH₃—N⁺(CH₃)₂—(CH₂)₁₅—CH₃, where the former is more amphiphilic than the later.

The concepts described relating to the incorporation of surface active quaternary ammonium salt antimicrobials are also applicable to additional additives that have catalytic chemical oxidation potential. Additives such as polyoxometalates, phthalocyanines, fullerenes, and metal oxide nanoparticles have all been incorporated into a variety of polymeric nano- and microfibers via the co-electrospinning of polymer solutions, such as nylon and polycarbonate, with physically dispersed additives. The resulting active nanofibers have shown concentration dependent chemical oxidation potential and are promising candidates for spontaneously self-decontaminating materials with high conversion efficiencies against target chemical agents. For example, polycarbonate nanofibers embedded with 0.5 wt % of a zinc phthalocyanine complex has shown complete conversion of an organophosphate simulant, Demeton S, to less harmful products within hours of exposure. The nanofibrous matrix shows enhanced activity against such chemical compounds compared to solution cast films of the same composition due to the increased surface area and greater availability of catalytic molecules at the material:air interface at the surface of the fibers. This catalyst availability leads to a much greater potential to convert molecular oxygen from the air into singlet oxygen, which is a known and potent chemical oxidizing agent. Synthetic manipulations of these oxidation catalysts may also be used to enhance segregation of the additives within the fibrous matrix, further permitting control over the spatial orientation and bulk vs. surface distribution of additives of interest.

The examples below include investigation of the differences between CTAB and C16EO1 in nylon and polycarbonate (PC) electrospun fibers. In general, both CTAB and C16EO1 affected each respective polymer system similarly. Additionally, regardless of whether CTAB or C16EO1 was used, incorporation of QAS resulted in opposite effects on fiber diameter and morphology in PC compared to those in nylon. Increasing QAS concentration in the polymer solutions was found to increase nylon fiber diameters and decrease PC fiber diameters. The incorporation of CTAB into nylon fibers resulted in incrementally increasing surface concentration of quaternary ammonium and anti-bacterial activity. Incorporation of C16EO1 into nylon, on the other hand, demonstrated maximum surface concentration and anti-bacterial activity in the 5 wt. % loaded fibers. Clearly, different modes of additive dispersion are occurring. The most significant factor affecting antibacterial activity of nylon fibers against Gram-positive bacteria was surface concentration of quaternary ammonium. This work has demonstrated surface concentration of amphiphilic QAS additive in electrospun nylon fibers.

The following examples are given to illustrate specific applications. These specific examples are not intended to limit the scope of the disclosure in this application.

### EXAMPLE 1

Materials—All solvents were reagent grade and used without further purification. Purchased starting materials were used without further purification. High molecular weight nylon 6,6 (Mₙ ˜60,000), poly(bisphenol A carbonate) pellets (M_{w} ˜64,000) (PC), and cetyltrimethylammonium bromide (CTAB) were purchased from Sigma Aldrich (St. Louis, Mo.) and used as received.

### EXAMPLE 2

Synthesis of quaternary ammonium biocides—C16EO1, a surface segregating QAS, was prepared following previously described procedures (Harney et al., ACS Appl. Mater. Interfaces 2009, 1, 39-41). Briefly, 7.81 mmol phosphorous tribromide was added drop-wise to a solution of 15.6 mmol ethylene glycol monomethyl ether maintained at 0° C. The solution was allowed to equilibrate to room temperature, and then heated to 90° C. when the solution turned yellow. After the solution was allowed to cool, 6 mL of 10% NaHCO₃ was added. The solution was extracted with diethyl ether and dried with MgSO₄. This product (1-methoxy-2-bromoethane) was reacted with N,N-dimethylhexadecylamine under nitrogen in ethanol at 83° C. for 24 hours. The resulting C16EO1 product was recrystallized to form an off-white powder. The structures of the resulting product (C16EO1) and CTAB are shown below.

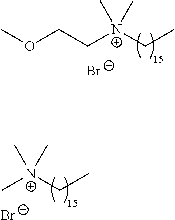

### EXAMPLE 3

Polymer preparation—Nylon solutions (15 wt. %) were prepared by mixing separately prepared solutions of nylon in formic acid (4 mL) and QAS in formic acid (1 mL) to result in 0, 1, 5, and 10 wt. % QAS relative to nylon. Preparation of comparable PC solutions (25 wt. %) were made by mixing solutions of PC in methylene chloride (4 mL) with QAS in DMF (1 mL).

### EXAMPLE 4

Electrospinning apparatus—A custom electrospinning apparatus consisting of a Bertan Series 205B high voltage power supply from Bertan Associates, Inc. and a NE-300 New Era syringe pump from New Era Pump Systems, Inc. was employed to fabricate electrospun fibers. A 10 mL syringe was filled with polymer solution, equipped with a flat-tipped stainless steel 22-gauge needle (Jensen Global, Santa Barbara, Calif.), and loaded into the syringe pump. The power supply was connected to the needle tip, set to 15 kV and the syringe pump flow rate was set to 15 μL/min. Fibers were collected on a grounded target covered in aluminum foil set perpendicular to the syringe at a distance of 15 cm from the needle tip. Electrospinning was terminated after a minimum of 450 μL of polymer solution was dispensed from the syringe.

### EXAMPLE 5

SEM analysis—Prior to scanning electron microscopy (SEM) analysis, the electrospun samples were coated with a 3 nm layer of gold using a Cressington 108 auto sputter coater equipped with a Cressington mtm20 thickness controller. A Carl Zeiss SMT Supra55 SEM was utilized to verify fiber formation and analyze morphology of electrospun polymers. Accelerating voltage was set between 3 and 5 kV. Fiber diameters were measured using Image J analysis software from which average fiber diameters were calculated (n≧100).

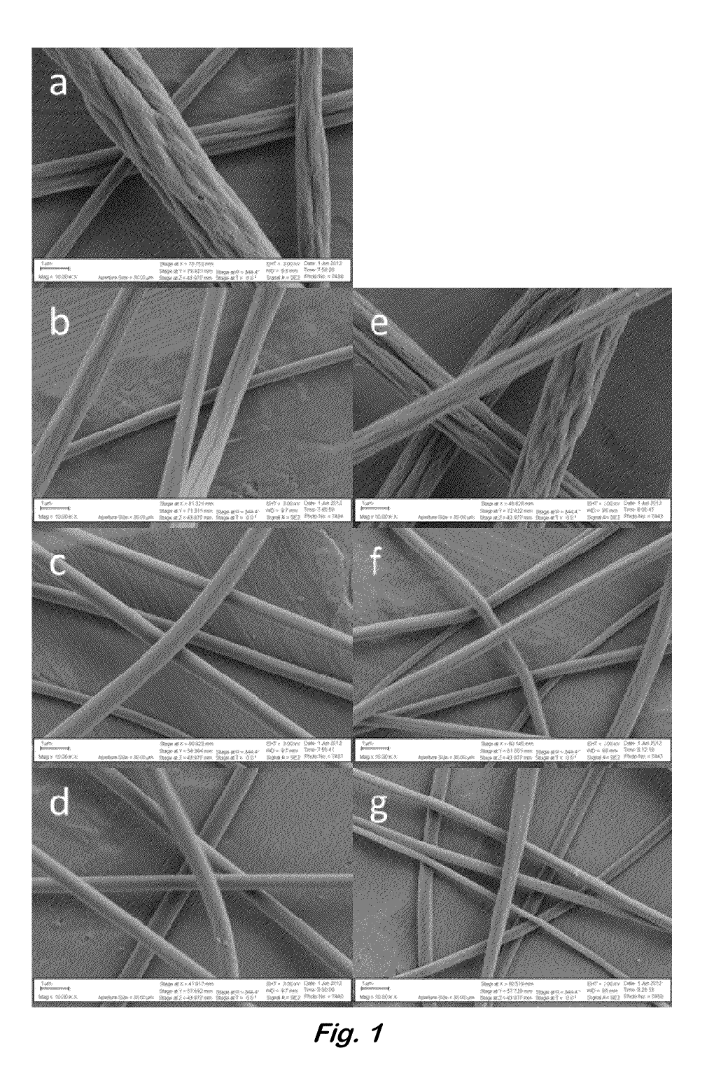

Fiber diameters of electrospun PC fibers were determined from SEM micrographs (FIG. 1). Mean fiber diameters of electrospun polymer formulations are presented in Table 1. Control PC fibers which did not contain QAS exhibited average fiber diameter of 2.34 μm. A negative correlation was observed upon addition of QAS into the electrospinning solution as fiber diameter decreased with increasing QAS concentration. Specifically, PC electrospun fibers loaded at 1 wt. % CTAB exhibited average diameters of 0.86 μm. PC fibers loaded 5 and 10 wt. % CTAB averaged diameters of 0.71 and 0.78 μm, respectively. Loading of PC polymer solution with 1 wt. % C16EO1 resulted in fibers with average diameter of 1.18 μm. At 5 and 10 wt. % C16EO1, the fiber diameters continued to decrease to 0.68 and 0.55 μm, respectively. The observed decrease in PC fiber diameters from incorporation of QAS corresponds with previous work (Kim et al., Eur. Polym. J. 2007, 43, 3146-3152) which incorporated benzyl triethylammonium chloride into PC solutions. On comparison of the effects of the two QAS, 1 wt. % loading of CTAB reduced PC fiber diameter to a greater extent than 1 wt. % loading with C16EO1. However, further loading of C16EO1 to 5 and 10 wt. % in PC polymer solution resulted in fibers with diameters that decreased to a greater extent than comparable 5 and 10 wt. % loadings of CTAB. It appears that while CTAB reaches a maximum in its effects on fiber diameter between 1 and 5 wt. %, C16EO1 continues to decrease PC fiber diameter up to, and perhaps beyond, 10 wt. % loading due to greater solubility of C16EO1 in the PC solution than CTAB. Due to differences in molecular weight between CTAB (364 g/mol) and C16EO1 (408 g/mol), there is a relative molar excess of CTAB to C16EO1 by a factor 1.12 for each comparable wt. % loading. Therefore, the effective solubility of CTAB at each particular wt. % loading is less than that of C16EO1, simply due to different molar concentrations.

TABLE 1
Average diameter of PC and nylon fibers
with increasing QAS concentrations

| Polymer Sol. | Additive | Mean Fiber Diameter |
|---|---|---|
| 25% PC | — | 2.34 ± 0.64 μm |
| 25% PC | 1 wt. % CTAB | 0.86 ± 0.33 |
| 25% PC | 5 wt. % CTAB | 0.71 ± 0.18 |
| 25% PC | 10 wt. % CTAB | 0.78 ± 0.14 |
| 25% PC | 1 wt. % C16EO1 | 1.18 ± 0.37 |
| 25% PC | 5 wt. % C16EO1 | 0.68 ± 0.22 |
| 25% PC | 10 wt. % C16EO1 | 0.55 ± 0.19 |
| 15% nylon | — | 91 ± 16 nm |
| 15% nylon | 1 wt. % CTAB | 193 ± 50 |
| 15% nylon | 5 wt. % CTAB | 234 ± 54 |
| 15% nylon | 10 wt. % CTAB | 278 ± 89 |
| 15% nylon | 1 wt. % C16EO1 | 203 ± 40 |
| 15% nylon | 5 wt. % C16EO1 | 175 ± 37 |
| 15% nylon | 10 wt. % C16EO1 | 253 ± 67 |

PC fiber morphology was also analyzed utilizing SEM. As concentrations of both CTAB (FIG. 1b-d) and C16EO1 (FIG. 1e-g) were increased from 1 to 10 wt. %, the surface texture of the PC fibers became increasingly smooth relative to the wrinkled texture exhibited by PC fibers formulated without QAS additives (FIG. 1a). While electrospun fibers with very small diameters inherently exhibit very high surface area to volume ratios, an increase in surface roughness results in a further increased ratio. The decrease in fiber roughness with increasing concentration of QAS resulted from increased solution conductivity due to ionic effects of QAS. Increase in solution conductivity has been demonstrated to affect surface morphology (Seo et al., Macromol. Mater. Eng. 2009, 294, 35-44). Wrinkled morphology has been observed in electrospun fibers due to continued solvent evaporation following fiber formation and subsequent fiber shrinkage (Koombhongse et al., Journal of Polymer Science Part B: Polymer Physics 2001, 39, 2598-2606). As such, the increase in QAS concentration in PC created fibers with smoother texture as a side-effect of decreased fiber diameter in that small fibers, which have higher surface area to volume ratios, allow for complete solvent evaporation during jet acceleration and whipping toward the target. Therefore, it is more likely for the PC fiber to form without entrapped solvent when QAS is added, avoiding continued evaporation after solidifying, and thus resulting in a smooth surface.

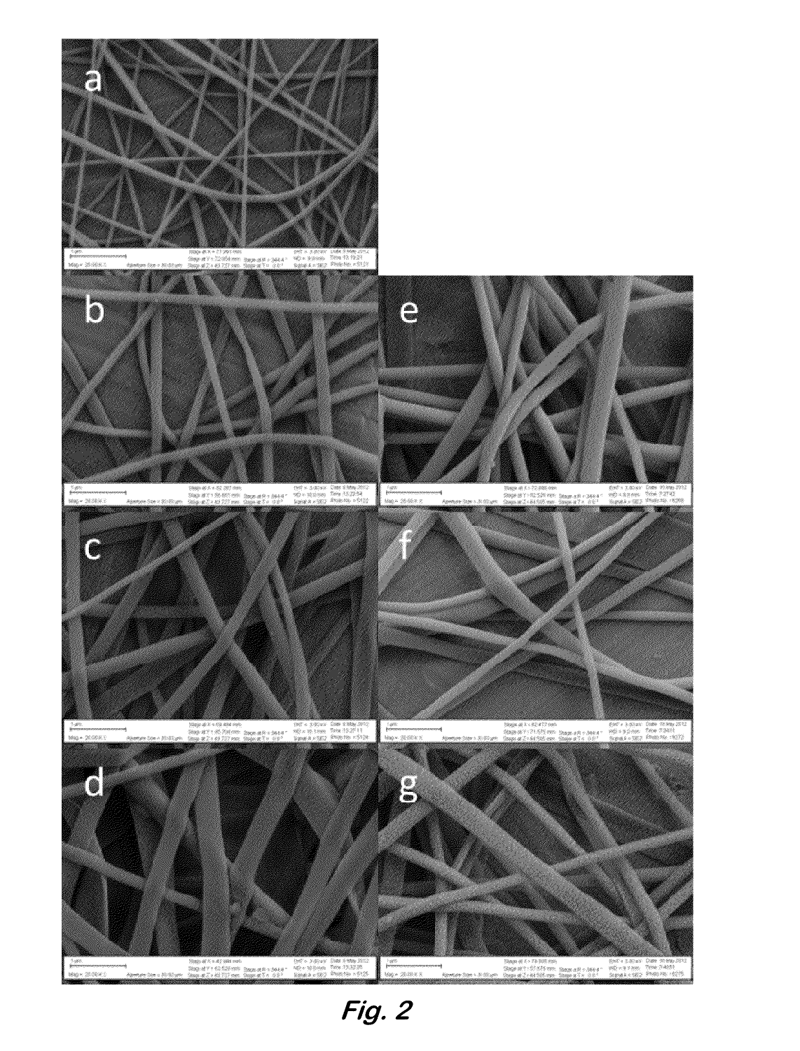

Nylon polymer solutions were also loaded with QAS, electrospun and subsequently analyzed. Overall, electrospinning of nylon from a 15% solution produced fibers with very small diameters within a relatively narrow range (Table 1). Without QAS additives, an average fiber diameter of 91 nm was achieved for nylon fibers. Incorporation of both CTAB and C16EO1 increased electrospun nylon fiber diameters which can be qualitatively observed FIG. 2. Specifically, the incorporation of CTAB at 1, 5, and 10 wt. % in nylon resulted in increasing fiber diameters of 193, 234, and 278 nm, respectively. Incorporation of C16EO1 at 1, 5, and 10 wt. % resulted in average fiber diameters of 203, 175, and 253 nm, respectively. For both QAS additives, standard deviation of the fiber diameter measurements increased as average fiber diameter increased, indicating greater fiber diameter dispersity for each respective fibrous mat. The observed increases in fiber diameters upon addition of the QAS agree with previous work (Mit-uppatham et al., Macromol. Chem. Phys. 2004, 205, 2327-2338) which demonstrated increases in nylon fiber diameters by increasing ionic strength of the polymer solutions by the addition of NaCl, LiCl, and MgCl₂. Changes in fiber diameter as a function of salt concentration were found to result from increased solution viscosity and its resultant effect on mass flow. Two factors may be playing roles in the observed increased fiber diameters of nylon fibers with increased QAS incorporation. Increased solution viscosity effectively causes the fiber to resist elongation and stretching once the polymer is extruded from the syringe tip. Furthermore, increased solution viscosity causes a greater mass flow of polymer which reduces the electrostatic charge density of the polymer jet since the volume of polymer jet is increased. Charge density plays a prominent role in intra-fiber Columbic repulsion which causes whipping and stretching. Therefore, if charge density is reduced, less whipping and stretching occur and fiber diameters remain relatively large (Mit-uppatham et al., Macromol. Chem. Phys. 2004, 205, 2327-2338).

Fiber morphology and surface texture of electrospun nylon fibers were analyzed by SEM micrographs, shown in FIG. 2. Nylon fibers electrospun without QAS (FIG. 2a) exhibited a cylindrical morphology and smooth texture, both of which were maintained upon incorporation of CTAB at concentrations 1, 5, and 10 wt. %. At 10 wt. % CTAB loading, few ribbon shaped fibers were also observed dispersed among the fibrous mat of primarily cylindrical fibers. The ribbon shapes, which can also be described as flat tubes, may result from an initial formation of a solid polymer skin on the electrospun fiber, which accumulates repulsive charges at two opposite points around the cylinder causing lateral stretching. Such behavior has been documented and described previously (Koombhongse et al., Journal of Polymer Science Part B: Polymer Physics 2001, 39, 2598-2606), where the lateral stretching in combination with diffusive solvent escape caused the tube to collapse into ultimate ribbon shape. Such behavior was only observed in the highest (10 wt. %) QAS loaded fibers perhaps because the high concentration of QAS effectively reduces nylon solubility, thereby accelerating the formation of polymer solid as a skin in the electrospun jet. Similar trends in fiber morphology were observed in nylon fibers loaded with up to 10 wt. % C16EO1 into the polymer solution as were from CTAB. Nylon fibers loaded with 10 wt. % C16EO1 exhibited rough surface features on the order of 5-20 nm (FIG. 2g). The QAS may have been concentrating at the surface and creating such features over time. Nylon fibers at 10 wt. % CTAB exhibited similar effects, but to a lesser degree than 10 wt. % C16EO1, and typically the nano-roughness was observed to only occur where two or more fibers are in contact with one another at intersections.

In comparison of the two polymer systems, incorporation of QAS in polymer solution resulted in opposite effects on fiber diameter and fiber morphology between PC and nylon. While nylon fibers increased in diameter with increased QAS concentration, the diameters of PC fibers decreased. Electrospun fiber diameters are critically affected by polymer solution electrical conductivity which in turn, is directly affected by salt concentration. Incorporation of salts into organic polymer solutions is known to result in decreased electrospun fiber diameters through a combination of increased solution conductivity and screening electrostatic repulsions (Reneker et al., J. Appl. Phys. 2000, 87, 4531-4547). However, this is only true if the initial solution has relatively poor electrical conductivity. Recent literature has also demonstrated that increasing salt concentration in an aqueous electrospinning solution tends to result in slightly larger fiber diameters (Arumugam et al., Macromol. Mater. Eng. 2009, 294, 45-53). Furthermore, increasing QAS concentration in PC fibers caused the fibers to become smoother and less textured. While at the highest QAS loading concentration in nylon, fibers demonstrated nano-roughness features and ribbon shaped fibers were dispersed throughout the nonwoven mat. Therefore, effects of QAS on solution conductivity were concluded to be responsible for the observed trends in fiber diameter and surface morphology.

### EXAMPLE 6

XPS analysis—X-ray photoelectron spectroscopic (XPS) analysis was performed using a Kratos Axis-Ultra DLD XPS spectrometer (Kratos, Manchester, U.K.) at the National Institute of Standards and Technology (NIST; Gaithersburg, Md.). A 300 μm×700 μm spot size was analyzed. For each sample, a low resolution survey was performed with a pass energy of 160 eV and step size of 0.5 eV. High resolution region scans were performed for all samples, each with a pass energy of 20 eV and step size of 0.1 eV. Spectra were analyzed using CasaXPS software.

The concentration of QAS at the surface was determined from calculations based on the ammonium XPS signal. The XPS ammonium signal was corrected to represent the QAS molecule by multiplying the percentage of the total XPS signal from quaternary ammonium N by the weight percent of N in the QAS molecule. The expected surface concentration was calculated by multiplying weight percent of N in the QAS molecule by the loading percent (0.01, 0.05, and 0.10). Values of respective loadings were compared to determine surface concentrating factor (observed/expected).

Surface concentrations of QAS in nylon fibers were investigated utilizing XPS analysis to elucidate the variation in antibacterial activity with QAS loading. Specifically, the concentration of QAS at the surface was determined by comparing the relative area of the quaternary ammonium N 1 s signal at binding energy of 402 eV for each sample. It has been shown that amphiphilic QAS additives in solvent-caste polyurethane and latex paint matrices spontaneously segregate to the polymer-air interface (Harney et al., ACS Appl. Mater. Interfaces 2009, 1, 39-41). Yet, this behavior has not been investigated in electrospun polymer fibers. Table 2 compares the observed surface concentration of QAS to expected surface concentration as if the QAS were evenly distributed throughout the entire volume of the fiber. The calculations used to determine these values were discussed in greater detail previously in the experimental section. Of fibers loaded with CTAB, the maximum surface concentration of QAS occurred in the 10 wt. % CTAB. Yet in the C16EO1 loaded fibers, the maximum QAS concentration occurred in the 5 wt. % C16EO1. The calculated theoretical values (% N calcd) demonstrate that if the QAS were evenly distributed throughout the polymer, an increasing linear trend of % N would result from QAS loading from 1 to 10 wt. %. While such a trend was observed for CTAB loaded nylon fibers, the C16EO1 fibers exhibited different behavior. It is clear that C16EO1 does not simply disperse evenly between the bulk and surface of the fibers. In fact, C16EO1 orients at the surface of the fiber as opposed to the bulk. The concentration factor (obsd/calc) clearly demonstrates the degrees to which the QAS preferentially orient at the nylon-air interface rather than evenly distribute throughout polymer volume in the 5 and 10 wt. % QAS (CTAB and C16EO1) loaded fibers. Nylon fibers loaded with 5 and 10 wt. % CTAB demonstrated surface concentration factors of 2.03 and 1.76, respectively. In comparison, 5 and 10 wt. % C16EO1 nylon fibers exhibited concentration factors 6.87 and 1.42, respectively. For both CTAB and C16EO1, the 5% loading concentration resulted in the greatest improvement in surface concentration as opposed to bulk distribution. Overall, the greatest surface concentration occurred in the 5% C16EO1 nylon fibers. Nylon loaded with 5% C16EO1 had greater surface concentration of QAS than the 10 wt. % C16EO1 nylon because at some point between 5 and 10 wt. % loading C16EO1 the critical micelle concentration (CMC) was exceeded. C16EO1, as an amphiphilic additive, preferentially forms micelles instead of aligning at the polymer-air interface beyond a certain concentration. The formation of micelles inherently minimizes surface energy as well as solvophobic interactions of the additives and therefore would facilitate reduced surface concentration as amphiphilic additive loading is increased beyond the CMC.

TABLE 2
Comparison of observed QAS surface concentration with calculated
surface concentration assuming even dispersion. Concentration factor
was determined by dividing % N observed by % N calculated

| Fibers | % N obsd | % N calcd | Conc. Factor |
|---|---|---|---|
| Control | 0.00 | 0 | NA |
| 1% CTAB | 0.00 | 0.04 | 0.00 |
| 5% CTAB | 0.44 | 0.22 | 2.03 |
| 10% CTAB | 0.76 | 0.43 | 1.76 |
| 1% C16EO1 | 0.00 | 0.04 | 0.00 |
| 5% C16EO1 | 1.33 | 0.19 | 6.87 |
| 10% C16EO1 | 0.55 | 0.39 | 1.42 |

### EXAMPLE 7

Anti-microbial testing—Staphylococcus aureus (S. aureus, ATCC 25923) was utilized in bacterial challenges for the electrospun fibrous mats. Bacteria were grown at 37° C. Log phase cells were harvested by centrifugation, counted on a hemocytometer using phase contrast microscopy, pelleted by centrifugation at 4000×g for 10 min, and resuspended in PBS at a concentration of 1×10⁹ CFU/mL. To prevent desiccation of the bacteria during testing, a hydration chamber was prepared consisting of a sterile 76×76 mm gauze pad placed in the bottom of a sterile 150×15 mm Petri dish. The gauze pad was saturated with 5 mL of sterile water and the test samples placed on top. A 10 μL aliquot containing 1×10⁷ bacteria was added to each test mat (approx. 188 mm²), and then placed in a hydration chamber at room temperature. After 2 hr of incubation, bacteria were recovered by placing the mat in a tube containing 5 mL sterile Letheen media, followed by 30 sec of vortexing. Serial dilutions were carried out, and incubated for 18 hr at 37° C. with agitation. Following incubation, the cultures were examined for the presence of turbidity, indicating bacterial growth. Each mat was tested in triplicate. Log kill was determined by the following: Log kill=7−highest dilution exhibiting bacterial growth. All bacterial challenge procedures were conducted using standard aseptic techniques in a BSL-2 hood.

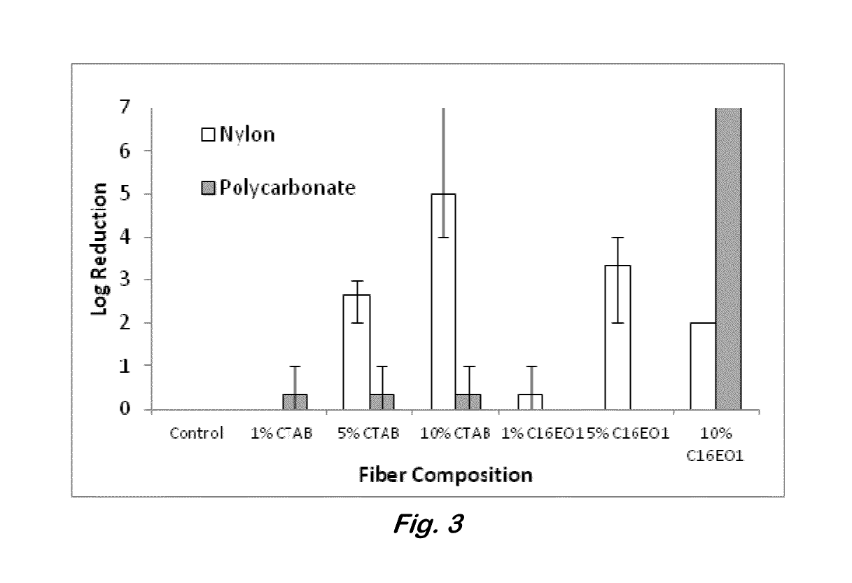

Electrospun PC and nylon fibers containing QAS were subjected to Gram-positive bacterial challenges against S. aureus. The average log reduction of S. aureus for each fiber formulation is presented in FIG. 3. The control PC fibers did not exhibit any reduction in S. aureus and each PC fiber loaded with CTAB demonstrated only minor antibacterial activity (0.33 log reduction). No bacterial reductions occurred on 1 and 5% C16EO1 PC fibers; however, a significant 7 log reduction of S. aureus occurred on 10 wt. % C16EO1 PC fibers. Incorporation of QAS in PC did not result in fibers with significant antimicrobial activity, except at the highest loading of amphiphilic QAS suggesting that the QAS do not surface segregate effectively in the PC electrospinning solution.

No relationship between Gram+bacterial reduction and fiber diameter of the PC electrospun polymers was observed. The smallest PC fiber diameter occurred in the 10% C16EO1 PC fibers which also demonstrated 7 log reduction of S. aureus; however, the 5% C16EO1 PC and 10% CTAB PC fibers also exhibited relatively small diameters, yet neither of which demonstrated significant reduction of S. aureus.

Electrospun nylon fibers containing QAS were also subjected to Gram-positive bacterial challenges against S. aureus (FIG. 3). The control, consisting of unmodified electrospun nylon, did not exhibit antibacterial activity. Nylon fibers which contained CTAB demonstrated significant log reductions at 5 and 10 wt. % loadings and nylon fibers containing C16EO1 exhibited antimicrobial activity for each loading concentration. Similar to the CTAB loaded nylon fibers, C16EO1 loaded nylon fibers demonstrated the greatest activity against S. aureus at 5 and 10 wt. % QAS with average log reductions of 3.3 and 2, respectively. Increased CTAB concentration in nylon fibers led to linear improvement reduction in Gram-positive bacteria, while nylon fibers loaded with C16EO1 exhibited the greatest bacterial reduction at 5 wt. %. Loading of C16EO1 beyond 5 wt. % reduces surface concentration of biocide as aggregation may be occurring resulting in a reduction of antibacterial activity. Additionally, fiber diameter may become a factor with increased C16EO1 loading as the largest fiber diameters of the nylon based fibers occurred 10 wt. % C16EO1 loading. Larger fiber diameters equate to lower surface area per volume of polymer which can cause reduced antimicrobial activity, particularly for a surface active material.

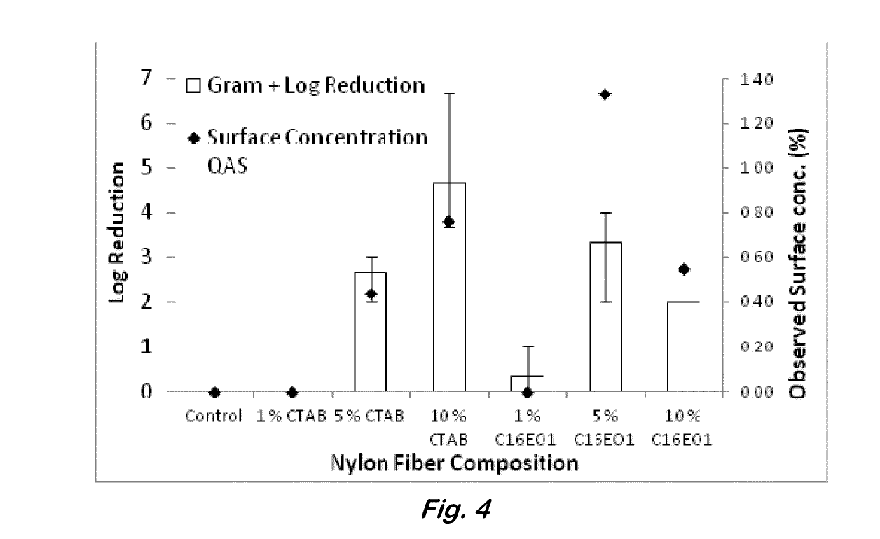

An overlay of S. aureus average log reduction and QAS surface concentration in electrospun nylon fibers is shown in FIG. 4. The plot clearly demonstrates the relationship between surface concentration of QAS and the antibacterial activity of the nylon fibers. The correlation between surface concentration of quaternary ammonium and anti-bacterial activity occurred in both CTAB and C16EO1 loaded nylon fibers. The discrepancy between surface concentration and relative log reduction of S. aureus for C16EO1 lies in the fact that CTAB is a more potent biocide.

Obviously, many modifications and variations are possible in light of the above teachings. It is therefore to be understood that the claimed subject matter may be practiced otherwise than as specifically described. Any reference to claim elements in the singular, e.g., using the articles “a,” “an,” “the,” or “said” is not construed as limiting the element to the singular.

What is claimed is:

1. A fiber comprising:
a polymeric matrix; and
a quarternary ammonium salt;
wherein the quarternary ammonium salt contains at least one aliphatic group and no aromatic groups;
wherein the quarternary ammonium salt is not covalently incorporated into the polymeric matrix; and
wherein the quarternary ammonium salt is present on both the surface and in the interior of the fiber.

2. The fiber of claim 1, wherein the concentration of the quarternary ammonium salt on the surface of the fiber is greater than the concentration of the quarternary ammonium salt in the interior of the fiber.

3. The fiber of claim 1, wherein the polymeric matrix comprises a nylon or a polycarbonate.

4. The fiber of claim 1, wherein the quarternary ammonium salt is amphiphilic.

5. The fiber of claim 1, wherein the quarternary ammonium salt has the formula:
X⁻R—CH₂—N⁺(CH₃)₂—(CH₂)ₙ—CH₃;
wherein X⁻ is an anion;
wherein R is CH₃—O—CH₂— or H—; and
wherein n is positive integer.

6. The fiber of claim 1, wherein the quarternary ammonium salt has the formula:
Br⁻CH₃O—CH₂—CH₂—N⁺(CH₃)₂—(CH₂)₁₅—CH₃.

7. The fiber of claim 1, wherein the quarternary ammonium salt has the formula:
Br⁻CH₃—N⁺(CH₃)₂—(CH₂)₁₅—CH₃.

8. The fiber of claim 1, wherein the fiber is made by electrospinning a solution of the polymeric matrix and the quarternary ammonium salt.

9. The fiber of claim 8, wherein the diameter of the fiber is no more than 5 microns.

10. A mat comprising one or more of the fibers of claim 8.

11. A method comprising:
electrospinning a solution of a polymeric matrix and a quarternary ammonium salt to produce a fiber comprising the polymeric matrix and the quarternary ammonium salt;
wherein the quarternary ammonium salt contains at least one aliphatic group and no aromatic groups;
wherein the quarternary ammonium salt is not covalently incorporated into the polymeric matrix; and
wherein the quarternary ammonium salt is present on both the surface and in the interior of the fiber.

12. The method of claim 11, wherein the electrospinning produces a mat of one or more of the fibers.

13. The method of claim 11, wherein the polymeric matrix comprises a nylon or a polycarbonate.

14. The method of claim 11, wherein the quarternary ammonium salt is amphiphilic.

15. The method of claim 11, wherein the quarternary ammonium salt has the formula:
X⁻R—CH₂—N⁺(CH₃)₂—(CH₂)ₙ—CH₃;
wherein X⁻ is an anion;
wherein R is CH₃—O—CH₂— or H—; and
wherein n is positive integer.

16. The method of claim 11, wherein the quarternary ammonium salt has the formula:
Br⁻CH₃—O—CH₂—CH₂—N⁺(CH₃)₂—(CH₂)₁₅—CH₃.

17. The method of claim 11, wherein the quarternary ammonium salt has the formula:
Br⁻CH₃—N⁺(CH₃)₂—(CH₂)₁₅—CH₃.

18. A fiber comprising:
a polymeric matrix; and
a oxidizing additive.

19. The fiber of claim 18, wherein the oxidizing additive is a polyoxometalate, a phthalocyanine, a fullerene, or a metal oxide nanoparticle.

20. The fiber of claim 18, wherein the fiber is made by electrospinning a solution of the polymeric matrix and the oxidizing additive.
